(19) United States
(12) Patent Application Publication
(10) Pub. No.: US 2002/0089140 A1
(43) Pub. Date: Jul. 11, 2002

(54) Rolling structure for a walker

(76) Inventor: Li-Wei Lu, Taichung City (TW)

Correspondence Address: Harrison and Egbert, 412 Main Street, 7th Floor, Houston, TX, 77002, US

(21) Appl. No.: 09/756,048

(22) Filed: Jan. 8, 2001

(51) Int. Cl. B60T 1/14; B62B 9/08

(52) U.S. Cl. 280/87.051; 188/5

(57) ABSTRACT

A walker sliding structure comprises a base, a plurality of rotational wheels mounted in the underside of the front end of the base, two directional wheels mounted at the rear end of the base, two elastic tension devices disposed between the directional wheels and the fastening columns, and a braking device disposed in a receiving cell which is located between the two directional wheels. The motion of the directional wheels is guided by the elastic tension devices in conjunction with the braking device.

### BACKGROUND OF THE INVENTION

1. Field of the Invention

The present invention relates generally to a walker for use by babies who are learning to walk, and more particularly to a sliding structure of the walker.

2. Description of Related Art

As shown in FIGS. 1 and 2, a prior art walker comprises a base 10 and a plurality of wheels 11 pivoted to the underside of the base 10. This prior art walker is rather primitive in design and is hazardous to the safety of a baby using the walker to learn to walk.

### BRIEF SUMMARY OF THE INVENTION

The primary objective of the present invention is to provide a walker which is safe to use by a baby to learn to walk.

It is another objective of the present invention to provide a walker with a braking device to enhance the safety of the walker.

In keeping with the principle of the present invention, the foregoing objectives of the present invention are attained by a walker comprising a base, two rotational wheels mounted at the front end of the base, two directional wheels mounted at the rear end of the base, two elastic tension devices disposed between the directional wheels and the fastening columns, and a braking device disposed in a receiving space that is located between the two directional wheels.

### BRIEF DESCIPTION OF THE SEVERAL VIEWS OF THE DRAWINGS

FIG. 1 shows a perspective view of a prior art walker.

FIG. 2 shows a schematic view of the prior art walker in action.

FIG. 3 shows a perspective view of the present invention.

FIG. 4 shows an exploded view of the braking device of the present invention.

FIG. 5 shows a sectional view of the braking device of the present invention in combination.

FIG. 6 shows an exploded view of the elastic tension device of the present invention.

FIG. 7 shows a sectional view of the elastic tension device of the present invention in combination.

FIG. 8 shows a schematic view of the elastic tension device of the present invention in action.

FIG. 9 shows a side schematic view of the present invention in use.

FIG. 10 shows another side schematic view of the present invention in use.

FIG. 11 shows a sectional view of the braking device of the present invention in combination.

FIG. 12 shows a schematic view of the present invention in operation.

FIG. 13 shows another schematic view of the present invention in operation.

FIG. 14 shows a sectional view of the braking device of the present invention in combination.

FIG. 15 shows a side schematic view of the present invention in use in such a manner that a baby is standing in the walker.

FIG. 16 shows a side schematic view of the present invention in use in such a manner that a baby is seated in the walker.

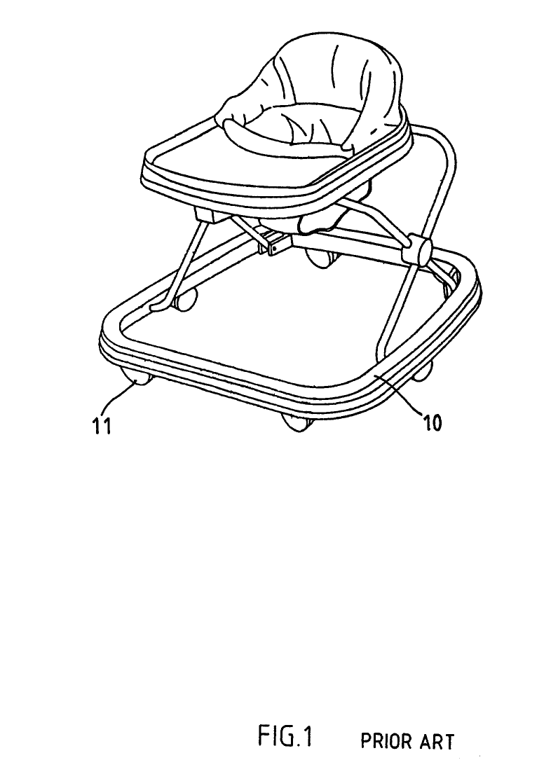

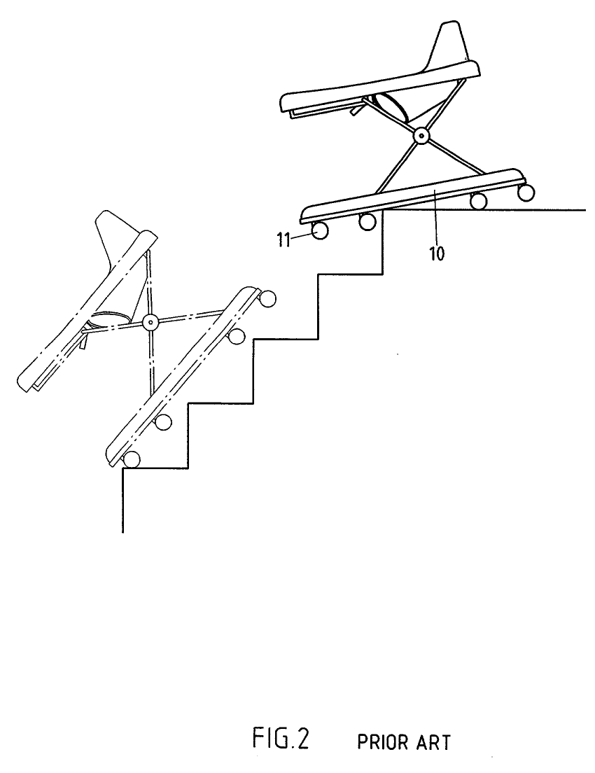

### DETAILED DESCRIPTION OF THE INVENTION

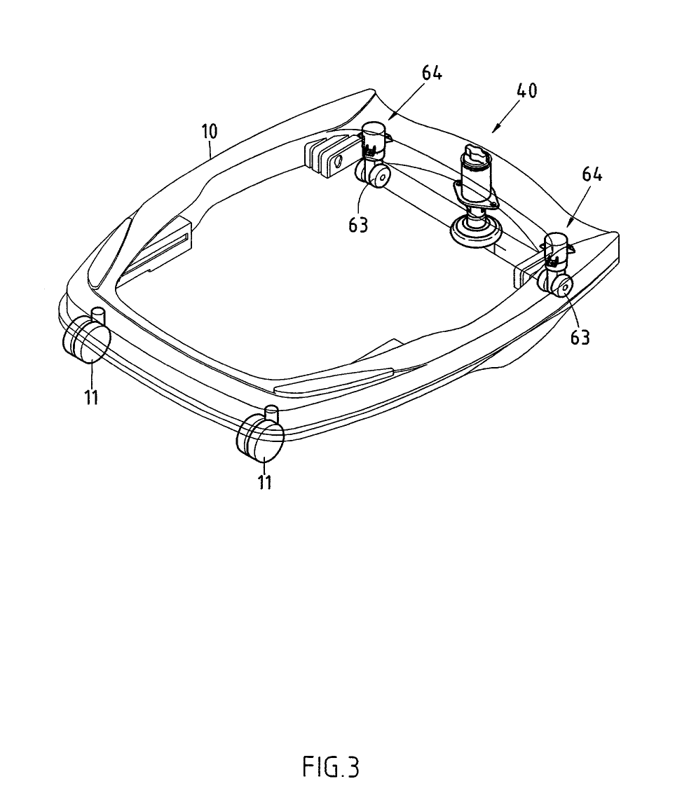

As shown in FIG. 3, a walker embodied in the present invention comprises a base 10, two rotational wheels 11 mounted in the underside of the front end of the base 10, two directional wheels 63 mounted in the underside of the rear end of the base 10, two elastic tension devices 64 mounted at a predetermined position of the rear end of the base 10, and a braking device 40 mounted at a predetermined position of the rear end of the base 10. The cruising motion of the directional wheels 63 is guided by the elastic tension devices in conjunction with the bracing device 40.

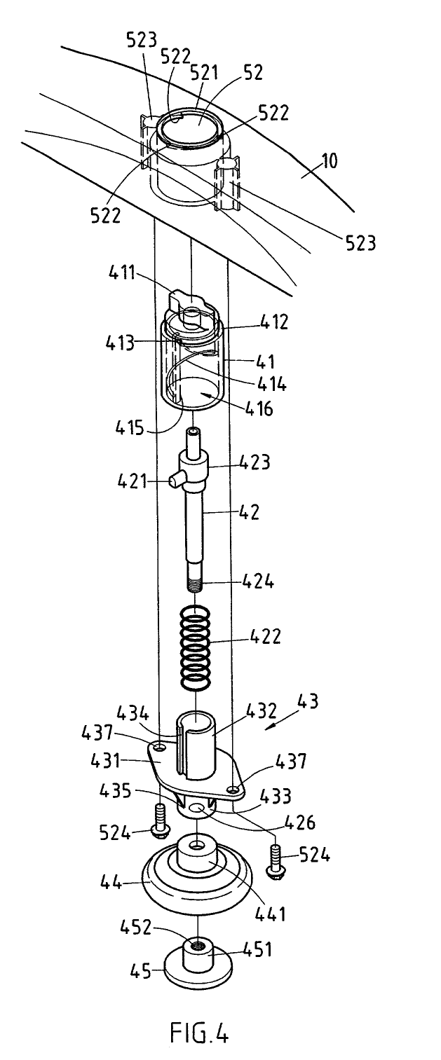

As shown in FIGS. 4 and 5, the braking device 40 comprises a top seat 41, a push rod 42, a guide seat 43, a bottom seat 44, a skidproof block 45, and a receiving cell 52.

The top seat 41 is of a tubular construction and is provided in the top with a rotary button 411 and an annular edge 412 which is provided with a retaining edge 413. The top seat 41 is further provided in the interior with a spiral guide edge 414 and a stop plate 415. The top seat 41 is further provided in the bottom with a guide port 416.

The push rod 42 is provided in proximity of the top end thereof with a protuberance 421, and a spring 422 fitted thereover such that the top end of the spring 422 is stopped by an enlarged portion 423 of the push rod 42. The push rod 42 is provided at the bottom end with a threaded rod 424.

The guide seat 43 has a plate body 431 which is provided in the top thereof with an upright and hollow upper tube 432, and in the underside thereof with an upright and hollow lower tube 433. The upper tube 32 is provided in the inner wall with a longitudinal cut hole 434. The lower tube 433 is provided at the bottom end of the interior thereof with a stop ring 435 which is in turn provided at the center with a through hole 436. The push rod 42 is received in the upper tube 432 of the guide seat 43 such that the protuberance 421 of the push rod 42 is received in the cut hole 434 of the upper tube 432, and that one end of the spring 422 of the push rod 42 urges the stop ring 435 of the lower tube 433 of the guide seat 43, and further that the threaded rod 424 of the push rod 42 is jutted out of the bottom end of the lower tube 432 via the through hole 436 of the stop ring 435 of the lower tube 433 of the guide seat 43. The upper tube 432 of the guide seat 43 and the push rod 42 are received in the top seat 41 via the guide port 416 of the top seat 11 such that the top edge of the protuberance 421 of the push rod 42 comes in contact with the spiral guide edge 414 of the top seat 41.

The bottom seat 44 is provided at the center of the top thereof with a columnar body 441 through which the threaded rod 424 of the push rod 42 is jutted out of the underside of the bottom seat 44.

The skidproof block 45 is provided at the center of the top thereof with a protruded tube 451 having an inner threaded hole 452 which is engaged with the threaded rod 424 of the push rod 42, thereby locating the skidproof block 45 in the underside of the bottom seat 44.

The receiving cell 52 is disposed in the rear end of the base 10 such that the receiving cell 52 is located between the two directional wheels 63. The receiving cell 52 is provided in the inner wall with an annular edge 521, and in the underside thereof with a plurality of stop edges 522. The bracing device 40 is received in the receiving cell 52 such that the pillars 523 of the receiving cell 52 are fastened with the fastening holes 437 of the plate body 431 of the guide seat 43 by screws 524, and that the rotary button 411 of the top seat 41 is jutted out of the top of the base 10, and further that the annular edge 412 of the top seat 41 comes in contact with the annular edge 521 of the receiving cell 52.

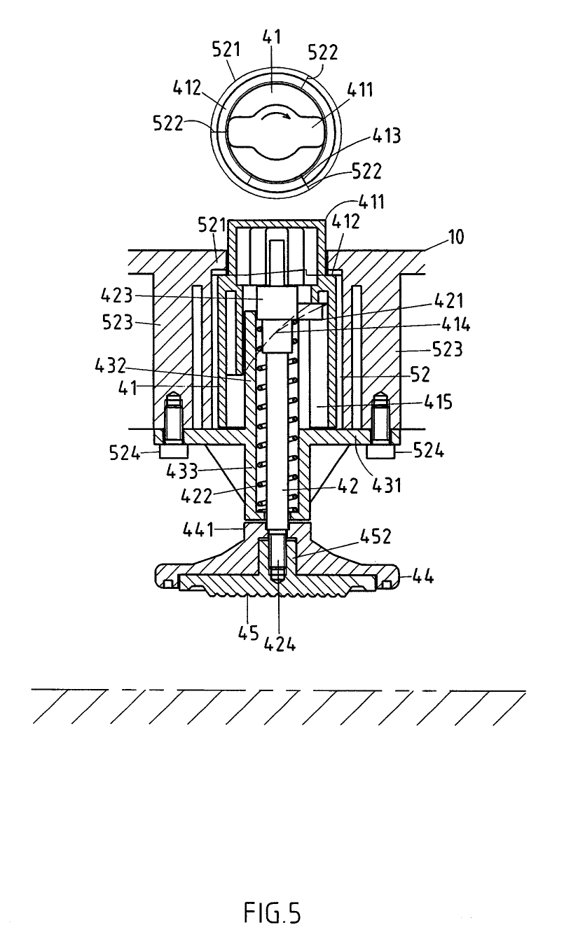

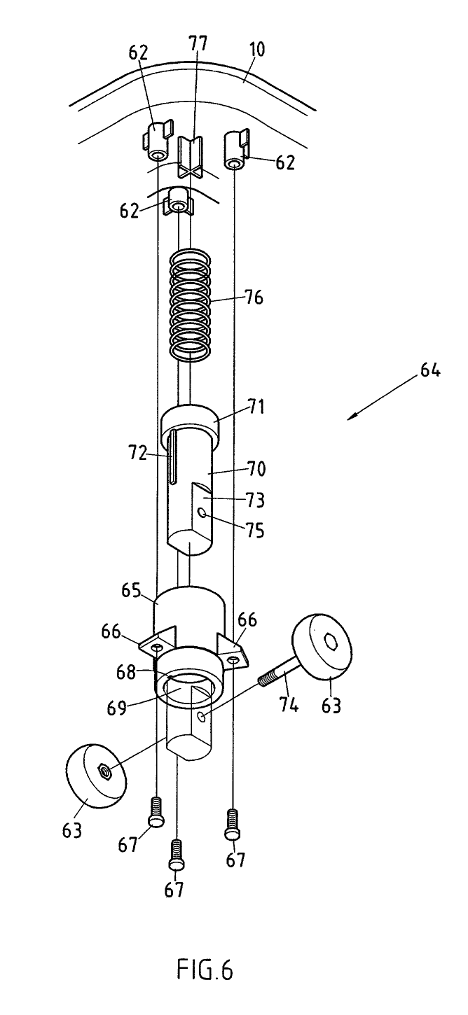

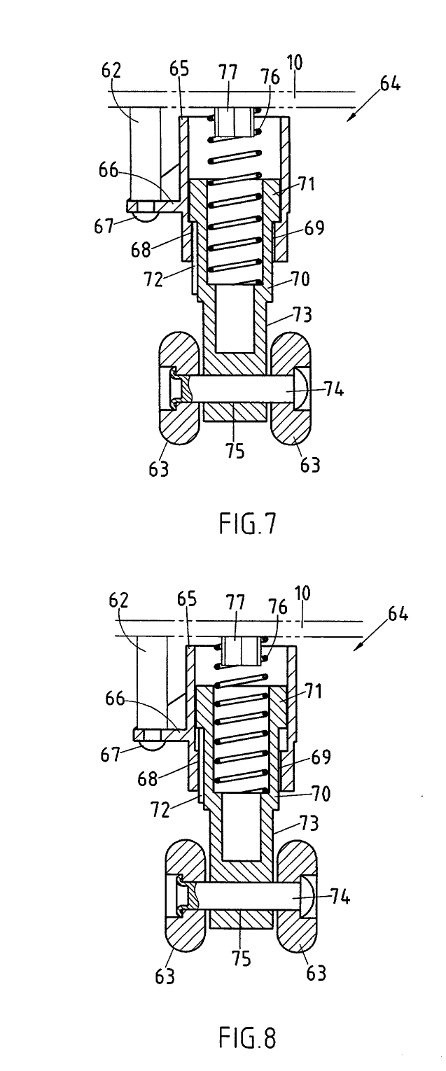

As shown in FIGS. 6, 7, and 8, the elastic tension device 64 comprises a locating shaft seat 65, a directional slide tube 70, and a tension spring 76.

The locating shaft seat 65 is provided with a support portion 66, which is fastened with the fastening column 62 of the base 10 by a fastening bolt 67. The locating shaft seat 65 is further provided with a stepped tube portion 69 having a directional slide slot 68.

The directional slide tube 70 is provided with a stop annular edge 71, and a directional rib 72 corresponding in location to the directional slide slot 68 of the locating shaft seat 65. The directional wheels 63 are fastened pivotally with the pivoting holes 75 of the cut surface 73 of the directional slide tube 70.

The tension spring 76 is disposed in the directional slide tube 70 such that one end of the tension spring 76 urges the closed end of the directional slide tube 70, and that other end of the tension spring 76 urges the position confining rib 77 of the base 10.

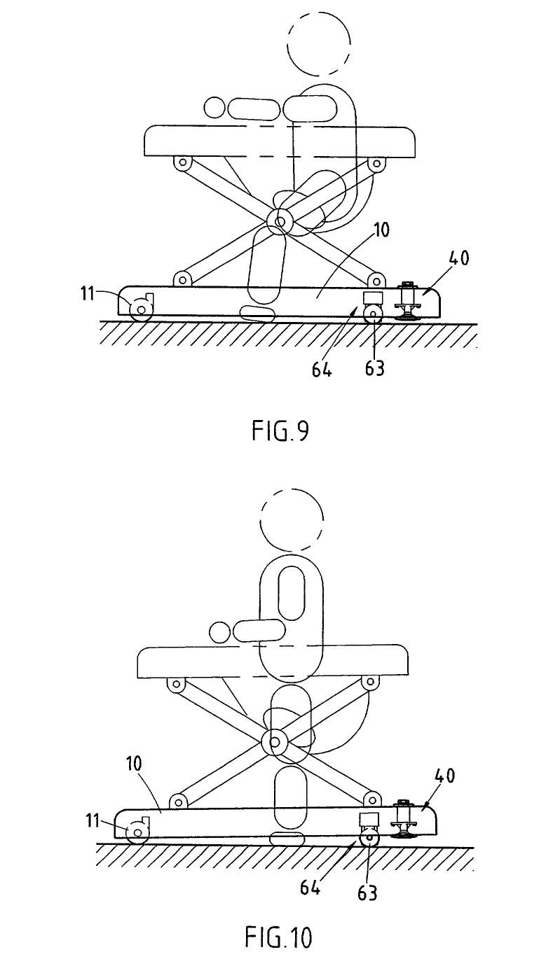

As shown in FIGS. 4, 5, 9, and 10, when the rotary button 411 is not turned, the protruded block 421 of the push rod 42 is located at the highest point of the spiral guide edge 414 of the top seat 41. As a result, the bottom seat 44 is located at the highest level. The top seat 41 is urged by the spring 422 of the push rod 42 such that the retaining edge 413 of the top seat 41 is rested against the stop edge 522 of the receiving cell 52. The bottom seat 44 located at the highest level. As a result, the braking device 40 is located above the surface on which the directional wheels 63 of the elastic tension device 64 slide. In other words, the braking device 40 is not on standby.

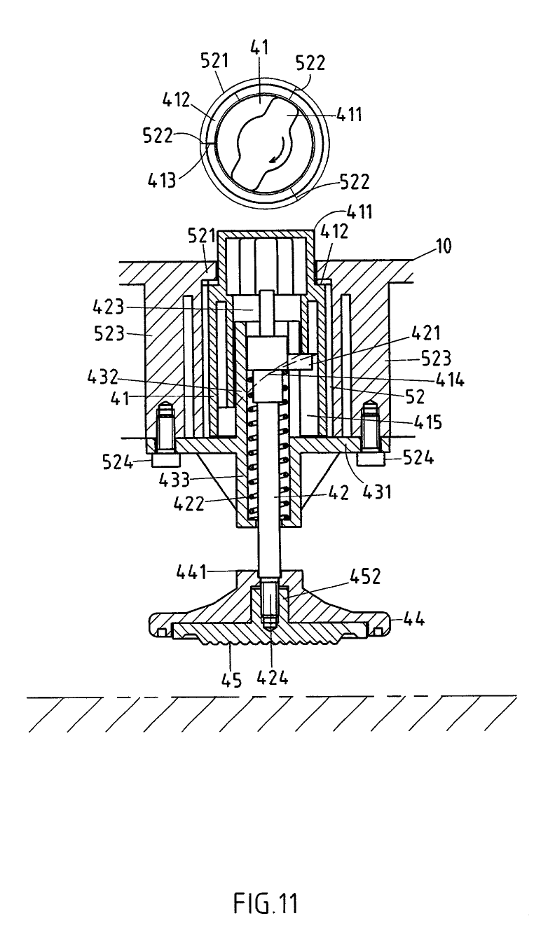

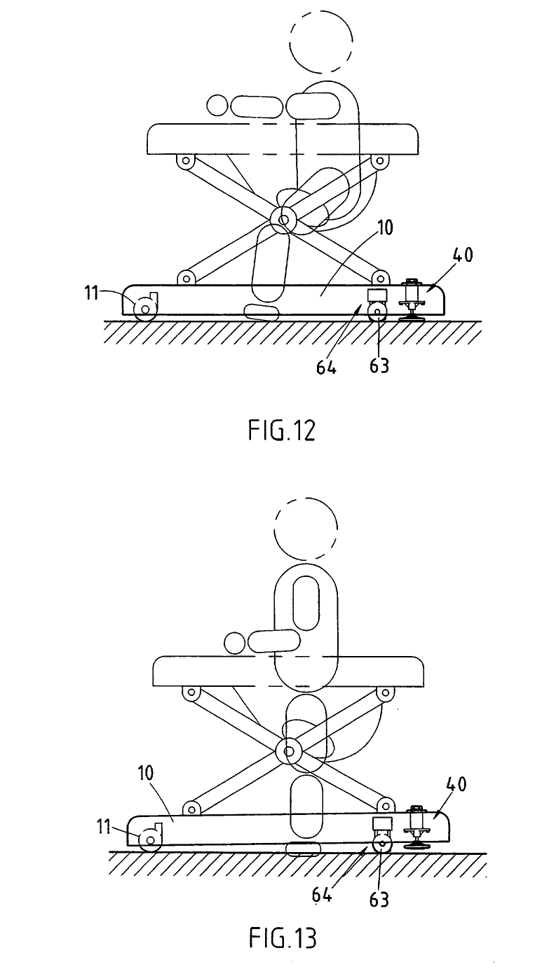

As shown in FIGS. 4, 11, 12, and 13, when the rotary button 411 is pressed and turned for an angle, the spiral guide edge 414 of the top seat 41 is actuated to turn so as to link the push rod 42. The bottom seat 44 is thus closer to the surface on which the walker moves. In the meantime, the retaining edge 413 of the top seat 41 is stopped by the stop edge 522 of the receiving cell 52. The elastic tension device 64 is under the pressure of the load. When the directional wheels 63 move on the surface, the skidproof block 45 of the bottom beat 44 of the braking device 40 comes in contact with the surface to stop the walker.

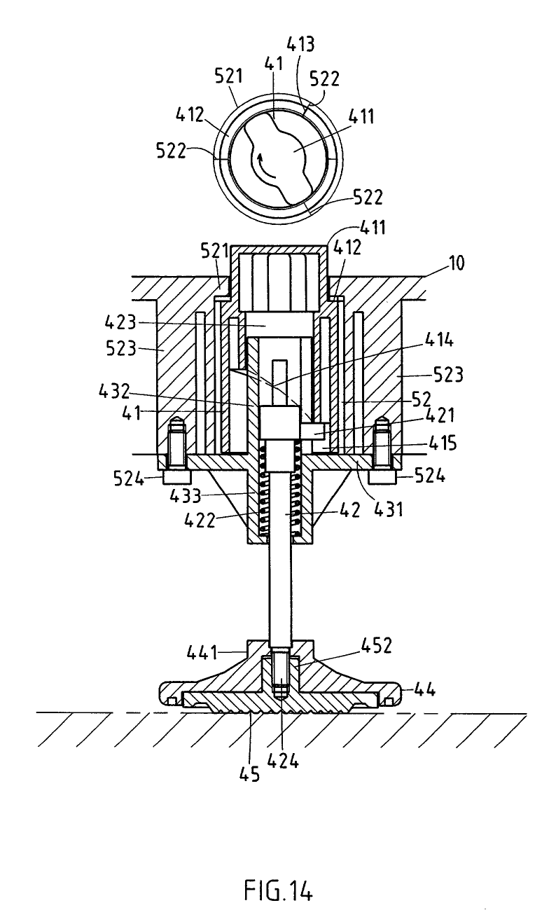

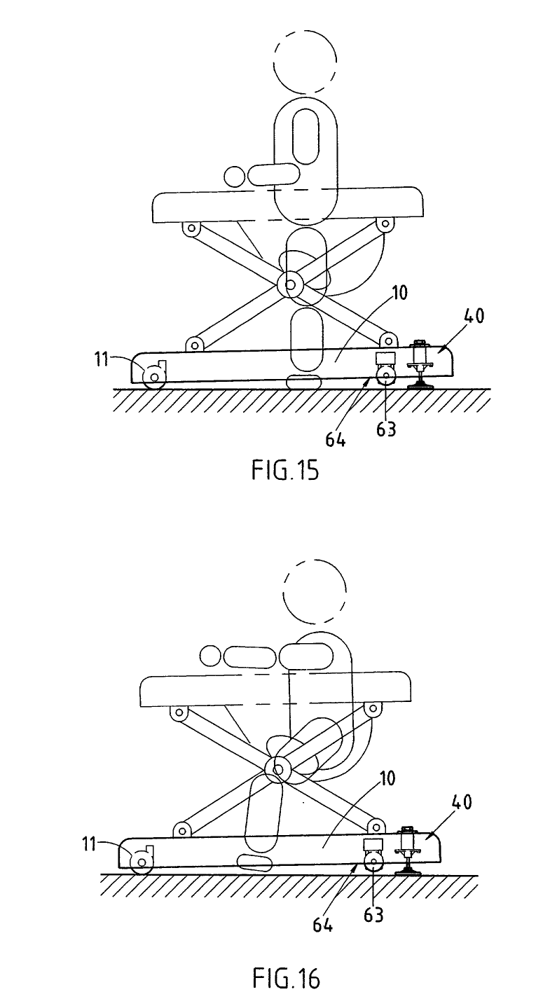

As shown in FIGS. 4, 14, 15, and 16, when the rotary button 411 of the top seat 41 is pressed and turned for a greater angle, the spiral guide edge 414 of the top seat 41 is actuated to force the protruded block 421 of the push rod 42 to locate at the lowest section of the top seat 41. As a result, the skidproof block 45 of the bottom seat 44 comes in contact with the ground surface, thereby disabling the directional wheels 63. The walker is capable of turning, without being able to slide.

I claim:

1. A water sliding structure comprising:
a base;
a plurality of rotational wheels mounted in the underside of a front end of said base;
two directional wheels mounted in the underside of a rear end of said base;
two elastic tension devices mounted at a predetermined position of the rear end of said base; and
a braking device mounted at a predetermined position of the rear end of said base.

2. The walker sliding structure as defined in claim 1, wherein said braking device comprises:
a top seat of a tubular construction and provided in a top with a rotary button and an annular edge which is provided with a retaining edge, said top seat further provided in an interior with a spiral guide edge and a stop plate, said top seat further provided in a bottom with a guide port;
a push rod provided with a protuberance and a spring fitted thereover such that a top end of said spring is stopped by an enlarged portion of said push rod, said push rod further provided at a bottom end with a threaded rod;
a guide seat having a plate body, said plate body being provided with a hollow upper tube and a hollow lower tube, said upper tube provided in an inner wall with a longitudinal cut hole, said lower tube provided at a bottom of the interior thereof with a stop ring which is in turn provided at the center with a through hole, said push rod being received in said upper tube of said guide seat such that said protuberance of said push rod is received in said cut hole of said upper tube, and that one end of said spring of said push rod urges said stop ring of said lower tube of said guide seat, and further that said threaded rod of said push rod is jutted out of the bottom end of said lower tube via said through hole of said stop ring of said lower tube of said guide seat, said upper tube of said guide seat and said push rod being received in said top seat via said guide port of said top seat such that a top edge of said protuberance of said push comes in contact with said spiral guide edge of said top seat;
a bottom seat provided at the center of a top thereof with a columnar body through which said threaded rod of said push rod is jutted out of the underside of said bottom seat;
a skidproof block provided at the center of a top thereof with a protruded tube having an inner threaded hole whereby said inner threaded hole is engaged with said threaded rod of said rod; and
a receiving cell disposed in the rear end of said base such that said receiving cell is located between said two directional wheels, said receiving cell provided in an inner wall with an annular edge, and in an underside with a plurality of stop edges, said braking device being disposed in said receiving cell such that a plurality of pillars of said receiving cell are fastened with a plurality of fastening holes of said plate body of said guide seat, and that said rotary button of said top seat is jutted out of the top of said base, and further that said annular edge of said top seat comes in contact with said annular edge of said receiving cell.

3. The walker sliding structure as defined in claim 1, wherein said elastic tension device comprises:
a locating shaft seat provided with a support portion which is fastened with said fastening column of said base, said locating shaft seat further provided with a stepped tube portion having a directional slide slot;
a directional slide tube provided with a stop annular edge and a directional rib corresponding in location to said directional slide slot of said locating shaft seat, said directional wheels being pivoted with a plurality of pivoting holes of a cut surface of said directional slide tube; and
a tension spring disposed in the directional slide tube such that one end of said tension spring urges a closed end of said directional slide, and that other end of said tension spring urges a position confining rib of said base.
